(19) United States
(12) Patent Application Publication
(10) Pub. No.: US 2017/0034017 A1
(43) Pub. Date: Feb. 2, 2017

(54) INFORMATION PROCESSING APPARATUS AND INFORMATION PROCESSING SYSTEM

(71) Applicant: Takayuki ONO, Tokyo (JP)

(72) Inventor: Takayuki ONO, Tokyo (JP)

(73) Assignee: Ricoh Company, Ltd., Tokyo (JP)

(21) Appl. No.: 15/213,647

(22) Filed: Jul. 19, 2016

(30) Foreign Application Priority Data
Jul. 28, 2015 (JP) 2015-149041

(51) Int. Cl. H04L 12/26; H04L 12/24; H04L 29/08

(52) U.S. Cl. CPC H04L 43/04; H04L 67/1097; H04L 41/069

(57) ABSTRACT

An information processing apparatus that is connected to a device management apparatus via a network is provided. The information processing apparatus includes a memory storing a program and a processor that executes the program to implement processes of acquiring a collection of historical information output in connection with execution of a process by a device managed by the device management apparatus, and analyzing the acquired collection of historical information based on a value of an information item included in each entry of historical information of the acquired collection of historical information. The information item included in the historical information is used to control an output level of historical information to be output. The processor of the information processing apparatus further implements processes of generating information in an output format based on the analysis result of the acquired collection of historical information, and outputting the generated information.

### CROSS-REFERENCE TO RELATED APPLICATIONS

The present application claims priority under 35 U.S.C. §119 to Japanese Patent Application No. 2015-149041 filed on Jul. 28, 2015, the entire contents of which are incorporated herein by reference.

### BACKGROUND OF THE INVENTION

1. Field of the Invention

The present disclosure relates to an information processing apparatus and an information processing system.

2. Description of the Related Art

In devices such as image forming apparatuses that are used in offices, for example, historical information (log information) is output and stored for various purposes.

For example, maintenance service providers and office device administrators may refer to log information to determine the state of a device or usage of the device. Also, device manufacturers may refer to log information to investigate the cause of a failure of a device, for example.

### SUMMARY OF THE INVENTION

According to one embodiment of the present invention, an information processing apparatus is provided that is connected to a device management apparatus via a network. The information processing apparatus includes a memory storing a program and a processor that executes the program to implement processes of acquiring a collection of historical information output in connection with execution of a process by a device managed by the device management apparatus, and analyzing the acquired collection of historical information based on a value of an information item included in each entry of historical information of the acquired collection of historical information. The information item included in the historical information is used to control an output level of historical information to be output by the device. The processor of the information processing apparatus further implements processes of generating information in an output format based on the analysis result of analyzing the acquired collection of historical information, and outputting the generated information in the output format.

### BRIEF DESCRIPTION OF THE DRAWINGS

FIG. 1 is a diagram illustrating an example configuration of a device management system according to a first embodiment of the present invention;

FIG. 2 is a diagram illustrating an example hardware configuration of a report generating apparatus according to the first embodiment;

FIG. 3 is a diagram illustrating an example functional configuration of the device management system according to the first embodiment;

FIG. 4 is a flowchart illustrating example process steps of a report information generating process;

FIG. 5 is a diagram illustrating an example of log information;

FIG. 6 is a table illustrating an example of report information according to the first embodiment;

FIG. 7 is a flowchart illustrating example process steps of a log information analyzing process according to the first embodiment;

FIG. 8 is a diagram illustrating an example setting screen for setting an output log level of log information to be output;

FIG. 9 is a table illustrating an example relationship between log level settings and corresponding output log levels of log information to be output;

FIG. 10 is a table illustrating an example of report information according to a second embodiment of the present invention;

FIG. 11 is a table illustrating an example of report information according to a third embodiment of the present invention; and

FIG. 12 is a flowchart illustrating example process steps of the log information analyzing process according to the third embodiment.

### DESCRIPTION OF THE EMBODIMENTS

In the following, embodiments of the present invention are described with reference to the accompanying drawings.

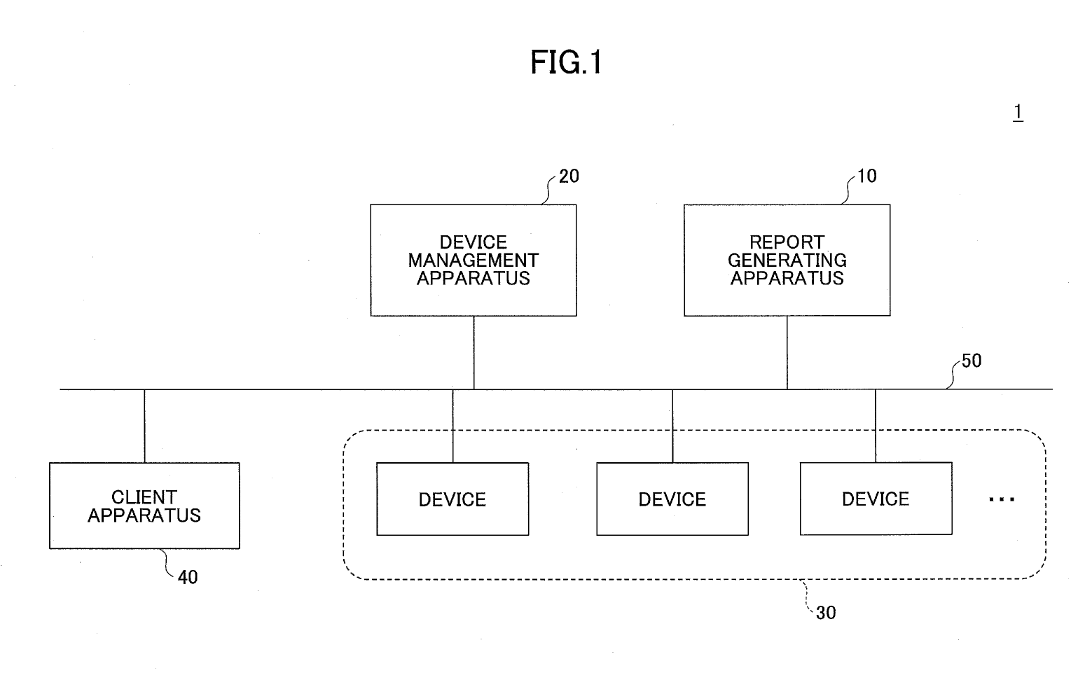

FIG. 1 is a diagram illustrating an example configuration of a device management system 1 according to a first embodiment of the present invention. In FIG. 1, the device management system 1 includes a report generating apparatus 10, a device management apparatus 20, a plurality of devices 30 (e.g., image forming apparatuses), and a client apparatus 40 that are connected to a network 50, such as a LAN (Local Area Network) or a WAN (Wide Area Network).

The device 30 may be an image forming apparatus, such as a multifunction peripheral (MFP), a copier, a scanner, or a printer, for example. In the following descriptions, the device 30 may also be referred to as “image forming apparatus 30”. However, that the device 30 is not limited to an image forming apparatus and may also be a projector, a digital whiteboard, a video conference system, a digital camera, or some other type of electronic device.

The device management apparatus 20 is implemented by at least one computer that is configured to periodically communicate with the image forming apparatuses 30 that are connected to the network 50 at predetermined intervals to collect historical information (hereinafter referred to as “log information”) relating to processes (jobs) that have been executed by the image forming apparatuses 30.

The report generating apparatus 10 is implemented by at least one computer that is configured to analyze the log information collected by the device management apparatus 20 and output the log information analysis result.

The client apparatus 40 is implemented by a computer that functions as a user interface for the report generating apparatus 10. That is, a user may input a request to the report generating apparatus 10 via the client apparatus 40. Specific examples of the client apparatus 40 include a PC (Personal Computer), a tablet terminal, a smart phone, and a mobile phone.

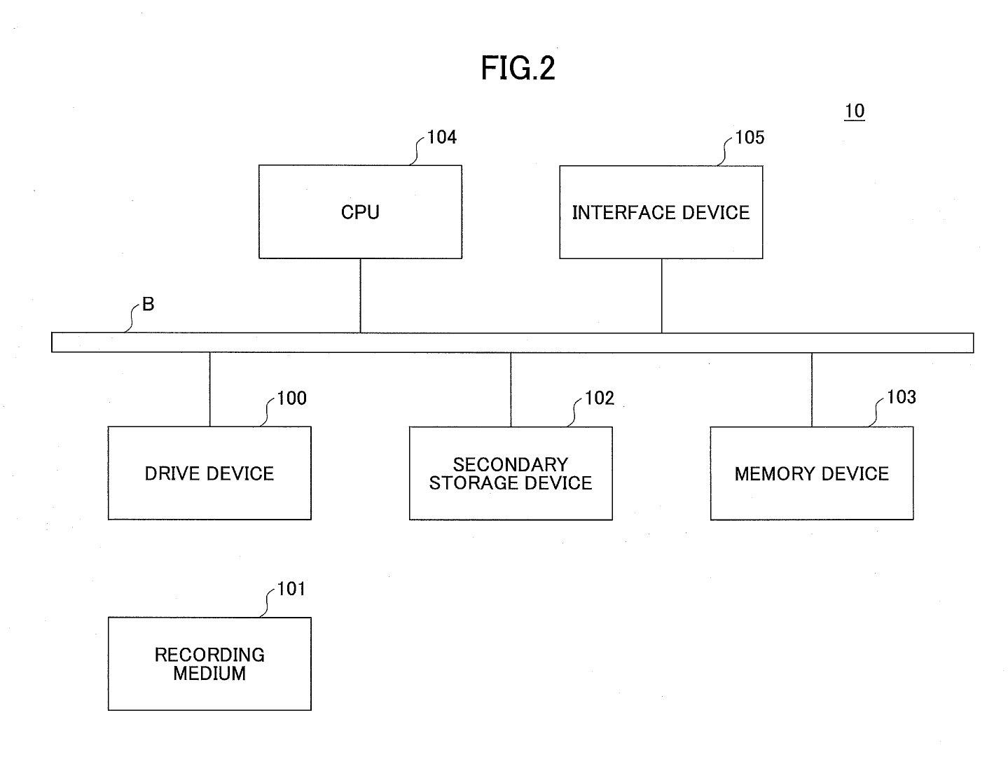

FIG. 2 is a diagram illustrating an example hardware configuration of the report generating apparatus 10 according to the first embodiment. In FIG. 2, the report generating apparatus 10 includes a drive device 100, a secondary storage device 102, a memory device 103, a CPU 104, and an interface device 105 that are interconnected by a bus B.

A program for implementing processes of the report generating apparatus 10 may be stored in a recording medium 101 such as a CD-ROM, for example. When the recording medium 101 storing the program is loaded in the drive device 100, the program may be retrieved from the recording medium 101 and installed in the secondary storage device 102 via the drive device 100, for example. However, the program does not necessarily have to be installed from the recording medium 101, and in other examples, the program may be downloaded from another computer via a network. The secondary storage device 102 stores the installed program, and also stores necessary files and data, for example.

The memory device 103 reads a program from the secondary storage device 102 in response to an instruction to start the program, and stores the read program. The CPU 104 implements functions of the report generating apparatus 10 based on the program stored in the memory device 103. The interface device 105 is used as an interface for establishing connection with a network.

Note that the device management apparatus 20 may have a hardware configuration similar to that illustrated in FIG. 2, for example.

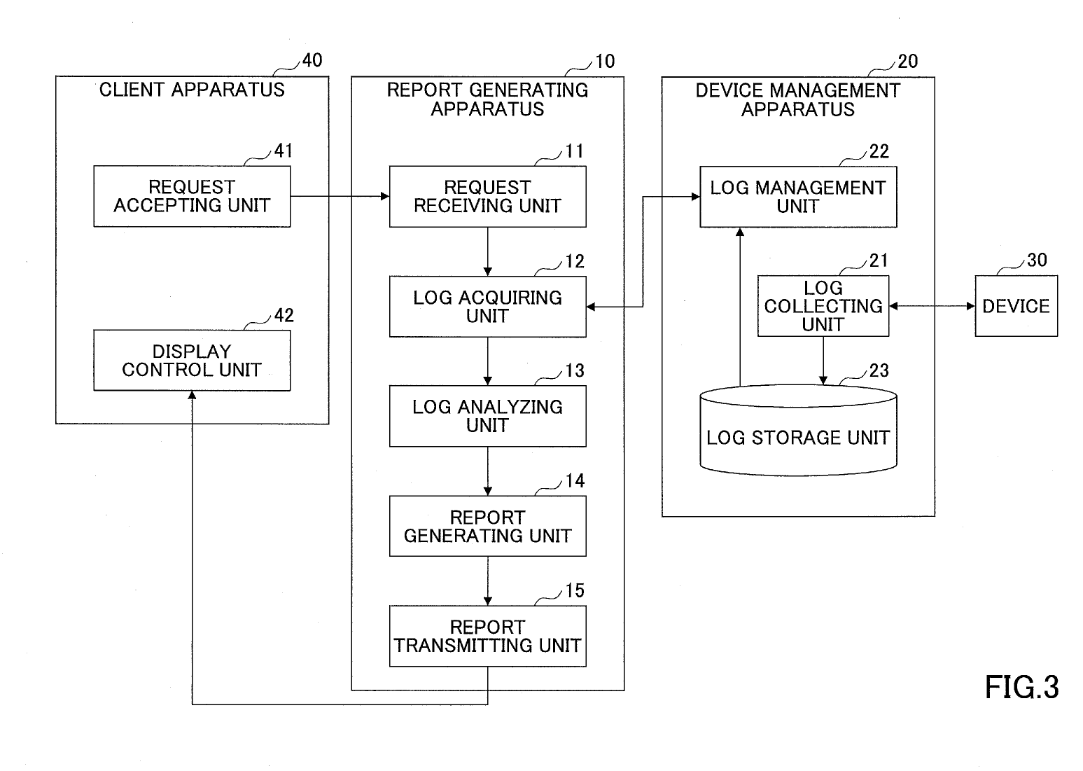

FIG. 3 is a diagram illustrating example functional configurations of the device management apparatus 20, the report generating apparatus 10, and the client apparatus 40 included in the device management system 1 according to the first embodiment. In FIG. 3, the device management apparatus 20 includes a log collecting unit 21 and a log management unit 22. These units may be implemented by processes executed by a CPU of the device management apparatus 20 based on one or more programs installed in the device management apparatus 20, for example. The device management apparatus 20 also includes a log storage unit 23. The log storage unit 23 may be implemented by a secondary storage device included in the device management apparatus 20, or a storage device connected to the device management apparatus 20 via a network, for example.

The log collecting unit 21 may periodically collect log information from the image forming apparatuses 30 at predetermined intervals, for example. Note that each of the image forming apparatuses 30 stores log information that has been internally output (or generated) within the image forming apparatus 30 in a storage device of the image forming apparatus 30. The log collecting unit 21 may collect log information that has been output by the image forming apparatus 30 over a time period from the last collection time to the present collection time, for example. Note that in some embodiments, log information may be actively transmitted from the image forming apparatus 30 to the log collecting unit 21. In this case, the log information may be sequentially transmitted to the log collecting unit 21 (e.g., each time log information is output), or the log information may be periodically transmitted to the log collecting unit 21.

The log storage unit 23 stores a collection of log information collected by the log collecting unit 21. The log management unit 22 manages the log information stored in the log storage unit 23. For example, in response to an acquisition request for log information from the report generating apparatus 10, the log management unit 22 transmits the collection of log information stored in the log storage unit 23 to the report generating apparatus 10.

The report generating apparatus 10 includes a request accepting unit 11, a log acquiring unit 12, a log analyzing unit 13, a report generating unit 14, and a report transmitting unit 15. These units may be implemented by processes executed by the CPU 104 based on one or more programs installed in the report generating apparatus 10, for example.

The request accepting unit 11 receives a request from the client apparatus 40. For example, the request accepting unit 11 may receive a report information generation request. Note that report information refers to information including a log information analysis result that is arranged into an output format. The log acquiring unit 12 acquires a collection of log information from the device management apparatus 20. The log analyzing unit 13 analyzes the collection of log information acquired by the log acquiring unit 12. The report generating unit 14 generates report information based on the login formation analysis result obtained by the log analyzing unit 13. The report transmitting unit 15 transmits the report information generated by the report generating unit 14 to the client apparatus 40.

The client apparatus 40 includes a request accepting unit 41 and a display control unit 42. The request accepting unit 41 accepts a report information generation request from a user and transmits the report information generation request to the report generating apparatus 10. The display control unit 42 receives report information transmitted from the report generating apparatus 10, and displays the received report information.

Note that in some embodiments, the report generating apparatus 10 may also implement the functions of the device management apparatus 20. That is, the report generating apparatus 10 and the device management apparatus 20 may be implemented by the same computer, for example. Alternatively, in some embodiments, the functions of the report generating apparatus 10 and the functions of the device management apparatus 20 may respectively be implemented by multiple computers.

In the following, a process executed by the report generating apparatus 10 is described. FIG. 4 is a flowchart illustrating example process steps of a report information generating process according to the present embodiment.

In step S101, the request accepting unit 11 accepts a report information generation request from the client apparatus 40. Note that the report information generation request may include information for limiting the log information to be analyzed (hereinafter referred to as “limiting condition”). For example, information specifying a certain time period may be included as a limiting condition in the report information generation request.

Then, in step S102, the log acquiring unit 12 acquires a collection of log information from the device management apparatus 20. Specifically, the log acquiring unit 12 transmits a log information acquisition request to the device management apparatus 20. If a limiting condition is included in the report information generation request, the limiting condition may be specified in the log information acquisition request. In response to the log information acquisition request, the log management unit 22 of the device management apparatus 20 acquires a collection of log information from the log storage unit 23. If a limiting condition is specified in the log information acquisition request, the log management unit 22 acquires a collection of log information satisfying the limiting condition from the log storage unit 23. The log management unit 22 transmits the acquired collection of log information to the log acquiring unit 12. In this way, the log acquiring unit 12 acquires the requested collection of log information.

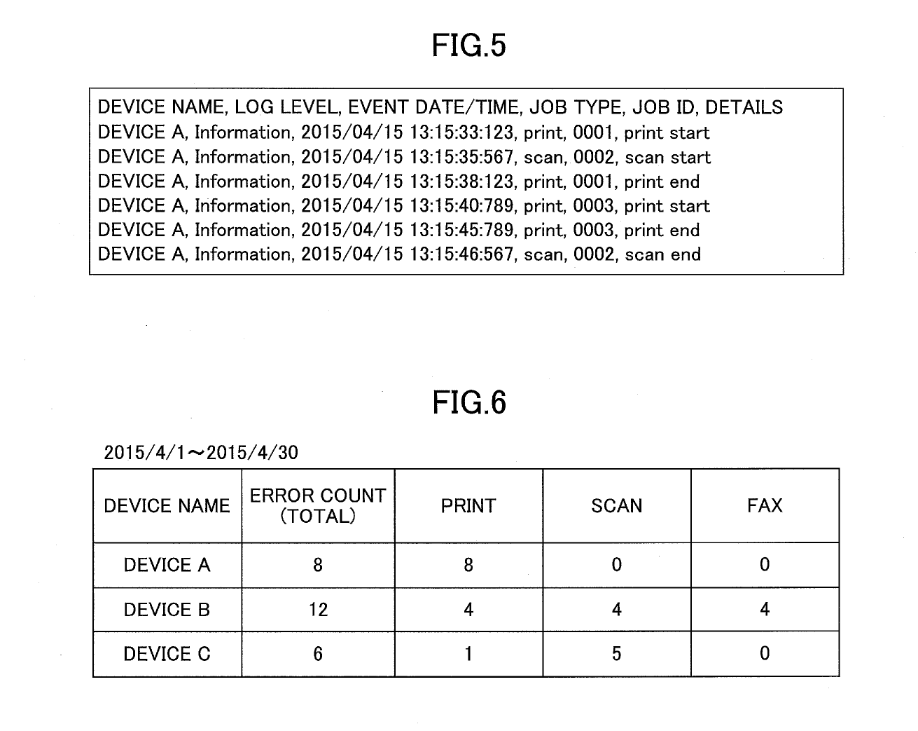

FIG. 5 is a diagram illustrating a specific example of log information. In FIG. 5, the log information includes information items, such as “device name”, “log level”, “event date/time”, “job type”, “job ID”, and “details”.

The “device name” indicates identification information of the image forming apparatus 30 that has output the log information. Note that the log information output by the image forming apparatus 30 does not necessarily have to include the device name of the image forming apparatus 30. For example, the device name may be included in the log information by the log collecting unit 21 of the device management apparatus 20. The “log level” is information for distinguishing the purpose or objective of the log information. The “event date/time” indicates the date and time of an event that has triggered the generation of the log information. The “job type” indicates the type of job (process) associated with the log information. The “job ID” indicates identification information identifying a specific job associated with the log information. Note that multiple entries of log information with a common job ID correspond to log information that has been output with respect to the same job. The “details” is information indicating specific details of the event for which the log information has been generated. For example, information indicating that a job has started or a job has ended may be indicated in the “details”.

In the following, the “log level” will be described in detail. In the present embodiment, log levels specifying the purpose or objective of log information include, “trace”, “debug”, “information”, “warning”, “error”, and “fatal”, for example. The log level “trace” may be assigned to log information output for the purpose of tracking processes executed by the image forming apparatus 30. The log level “debug” may be assigned to log information output for the purpose of debugging processes executed by the image forming apparatus 30. The log level “information” may be assigned to log information to be output for the purpose of recording the history of processes executed by the image forming apparatus 30. The log level “warning” may be assigned to log information output for the purpose of notification of the occurrence of a minor abnormality in the image forming apparatus 30 or notification of an impending occurrence of an abnormality. Note that examples of minor abnormalities that may trigger the generation of log information with the log level “warning” may include minor problems, such as the image forming apparatus 30 being out of paper or out of toner, that can be solved by simply replacing consumable parts, for example. The log level “error” may be assigned to log information output for the purpose of notification of the occurrence of an abnormality in the image forming apparatus 30. An abnormality that may trigger the generation of log information with the log level “error” may include the cancellation of a job, for example. The log level “fatal” may be assigned to log information output for the purpose of notification of the occurrence of a fatal abnormality in the image forming apparatus 30. Fatal abnormalities that may trigger the output of log information with the log level “fatal” may include fatal problems in the image forming apparatus 30 that would hinder continued use of the image forming apparatus 30, for example.

Referring back to FIG. 4, in step S103, the log analyzing unit 13 analyzes the collection of log information acquired by the log acquiring unit 12. In the present embodiment, analysis is performed based on the log level of the log information.

Then, in step S104, the report generating unit 14 generates report information by arranging the log information analysis result obtained by the log analyzing unit 13 into an output format. Then, in step S105, the report transmitting unit 15 transmits (outputs) the generated report information to the client apparatus 40 corresponding to the sender of the report information generation request.

Upon receiving the report information, the display control unit 42 of the client apparatus 40 displays the received report information.

FIG. 6 is a table illustrating an example of report information according to the first embodiment. In the report information of FIG. 6, the first column (“error count (total)”) indicates the number of times an error has occurred in each individual device. The second column (“print”) indicates the number of times an error relating to a print job has occurred in each individual device. The third column (“scan”) indicates the number of times an error relating a scan job has occurred in each individual device. The fourth column (“fax”) indicates the number of times an error relating a fax job has occurred in each individual device. Note that the report information of FIG. 6 relates to log information with the “event date/time” within the period from Apr. 1, 2015 to Apr. 30, 2015.

For example, a user may refer to the report information of FIG. 6 to identify an image forming apparatus 30 with a high error count and consider replacing the image forming apparatus 30.

In the following, process operations performed in step S103 of FIG. 4 to generate the report information as illustrated in FIG. 6 are described.

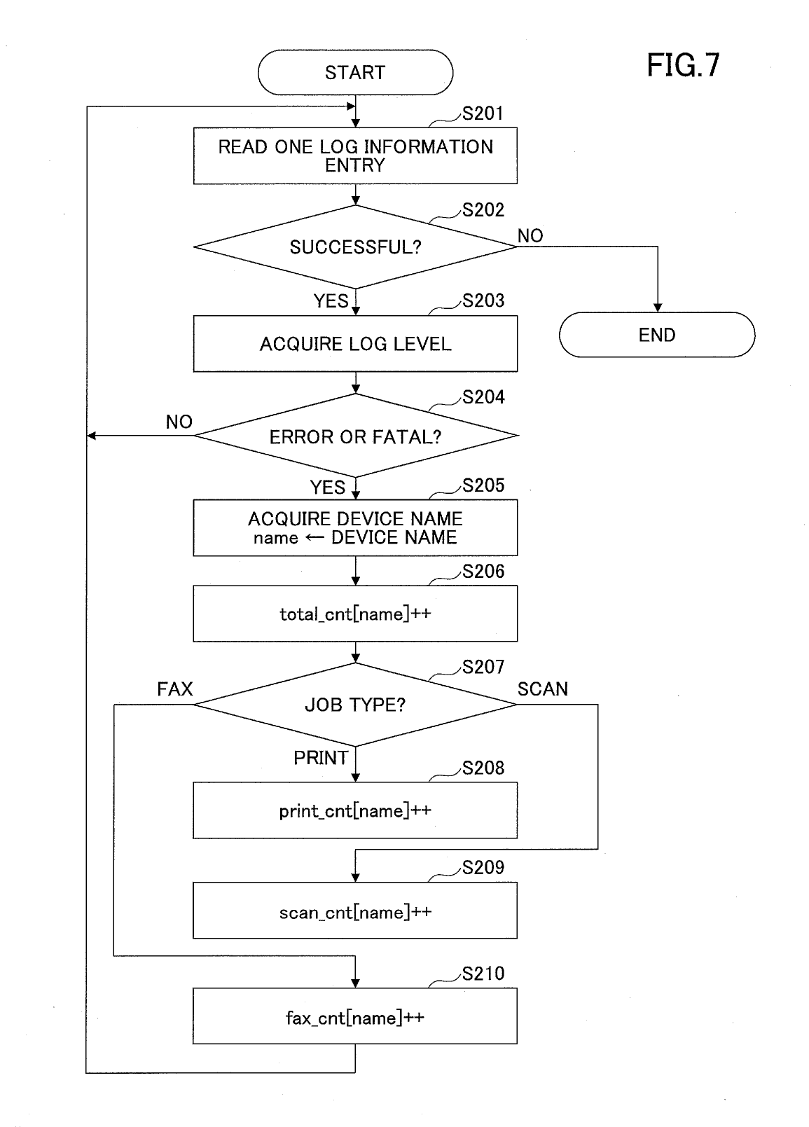

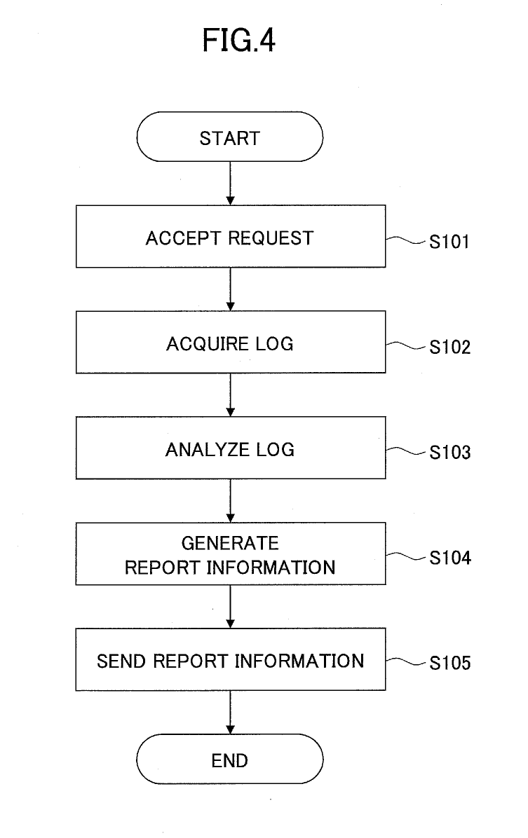

FIG. 7 is a flowchart illustrating example process steps of a log information analyzing process for analyzing a collection of log information according to the first embodiment.

In step S201, the log analyzing unit 13 reads (retrieves) one entry of log information from a collection of log information acquired by the log acquiring unit 12. If the log information has been successfully retrieved (YES in step S202), the log analyzing unit 13 acquires the value of the log level from the retrieved log information (hereinafter referred to as “target log information”) (step S203).

Then, the log analyzing unit 13 determines whether the value of the log level acquired from the target log information corresponds to “error” or “fatal” (S204). If the acquired value of the log level is neither “error” nor “fatal” (NO in step S204), the process returns to step S201. If the acquired value of the log level is either “error” or “fatal” (YES in step S204), the log analyzing unit 13 acquires the device name of the target log information, and assigns the acquired device name as a value for the variable “name” (S205).

Then, the log analyzing unit 13 adds 1 to “total_cnt[name]” (S206). Note that “total_cnt” is an association list for storing an error count for each device name, and “total_cnt[name]” is an element of the association list for storing the value of the error count for the device name of the target log information. Note that “total_cnt” corresponds to the first column of FIG. 6.

Then, the log analyzing unit 13 refers to the value of the job type of the target log information (S207). If the value of the job type is “print”, the log analyzing unit 13 adds 1 to “print_cnt[name]” (S208). Note that “print_cnt” is an association list for storing the error count for errors relating to a print job for each device name, and “print_cnt[name]” is an element of the association list for storing the value of the error count for the device name of the target log information.

Alternatively, if the value of the job type of the target log information is “scan”, the log analyzing unit 13 adds 1 to “scan_cnt[name]” (S209). Note that “scan_cnt” is an association list for storing the error count of errors relating to a scan job for each device name, and “scan_cnt[name]” is an element of the association list for storing the value of the error count for the device name of the target log information.

Alternatively, if the value of the job type is “fax”, the log analyzing unit 13 adds 1 to “fax_cnt[name]” (S210). Note that “fax_cnt” is an association list for storing the error count of errors relating to a fax job for each device name, and “fax_cnt[name]” is an element of the association list for storing the value of the error count for the device name of the target log information.

When the processes of step S201 and subsequent process steps have been executed with respect to all of the log information entries included in the collection of log information acquired by the log acquiring unit 12 (NO in step S202), the process of FIG. 7 is ended. In this way, the report information as illustrated in FIG. 6 may be obtained.

That is, in FIG. 7, the log analyzing unit 13 extracts a collection of log information with the value “error” or “fatal” as the log level from the collection of log information acquired by the log acquiring unit 12, sorts the extracted collection of log information into a plurality of groups based on the value of the job type of the log information, and counts the number log information entries belonging to each group. In this way, an error count for each device name and for each job type may be obtained.

Note that log information with the log level “trace” or “debug” may be output when investigating the cause of the occurrence of an abnormality in the image forming apparatus 30, for example. When such log information is output during normal operations, the storage capacity of the storage device of the image forming apparatus 30 may be overloaded with log information, for example. Also, there may be cases where only the output of log information with the log level “error” or “fatal” is necessary or desired. Thus, in some embodiments, the log level of log information to be output may be set up for each image forming apparatus 30, for example.

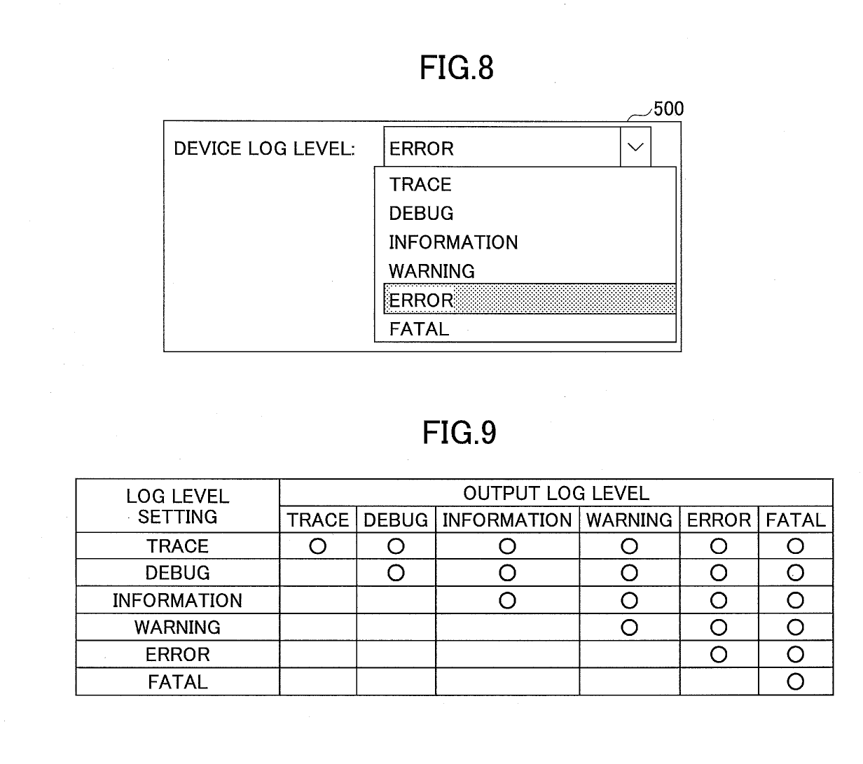

FIG. 8 is an example display of an output log level setting screen. The setting screen 500 of FIG. 8 may be displayed on an operation panel of the image forming apparatus 30 or the client apparatus 40, for example. In FIG. 8, all of the log levels are displayed as options in a drop-down list, and one of the log levels may be selected therefrom. The selected log level is set up as a log level setting for a setting target image forming apparatus 30. Note that if the setting screen 500 is displayed on the operation panel of the image forming apparatus 30, the image forming apparatus 30 displaying the setting screen 500 corresponds to the setting target image forming apparatus 30. Also, if the setting screen 500 is displayed on the client apparatus 40, the setting target image forming apparatus 30 may be an image forming apparatus 30 selected by a user at the client apparatus 40, or the setting target image forming apparatus 30 may be all of the image forming apparatuses 30 managed by the device management system 1, for example.

Note that log levels to be output (output log level) may vary from one image forming apparatus 30 to another depending on the log level setting of each image forming apparatus 30 as illustrated in FIG. 9, for example.

FIG. 9 is a table indicating an example relationship between log level settings and output log levels. In the table of FIG. 9, the row headers indicate the log level settings, and the column headers indicate log levels to be output. If a circle ◯ is indicated in a given row of a column representing a log level, this means that the corresponding log level represented by the column is to be output when the log level setting represented by the given row is set up.

For example, according to FIG. 9, if “trace” is set up as the log level setting, log information of all log levels is to be output. If “debug” is set up as the log level setting, log information of all log levels other than the log level “trace” is to be output. On the other hand, if “error” is set up as the log level setting, only log information with the log level “error” or “fatal” is to be output. Further, if “fatal” is set up as the log level setting, only log information with the log level “fatal” is to be output.

As illustrated in FIG. 9, the log level may be an information item used for controlling the output level of log information to be output (generated). That is, the log level may be an information item used to narrow down or restrict the log information to be output by the image forming apparatus 30.

As described above, according to an aspect of the first embodiment, a collection of log information acquired from an image forming apparatus 30 may be analyzed based on the log level of the log information, and report information including the log information analysis result may be generated. Thus, even if several tens to several thousands of image forming apparatuses 30 are being managed, a user may refer to the report information to efficiently manage the image forming apparatuses 30. For example, the user may refer to the report information to identify an image forming apparatus 30 with a high error count (image forming apparatus 30 prone to error occurrences) and consider replacing such image forming apparatus 30. Replacing an image forming apparatus 30 prone to errors in this manner may lead to improvement in operational efficiency, for example. That is, according to an aspect of the first embodiment, the operation burden of managing the image forming apparatuses 30 based on log information output by the image forming apparatus 30 may be reduced.

In the following, a second embodiment of the present invention is described. Note that the following descriptions mainly relate to features of the second embodiment that differ from those of the first embodiment. Thus, features of the second embodiment that are not specifically mentioned below may be substantially identical to the first embodiment.

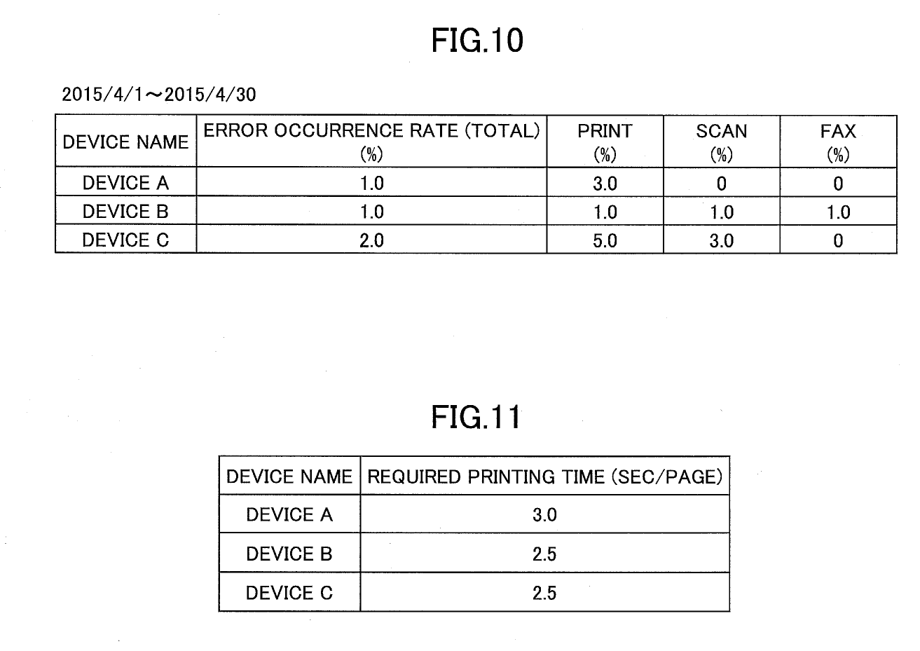

In the second embodiment, the content of the report information is different from that of the first embodiment. FIG. 10 is a table representing an example of report information according to the second embodiment.

The report information of FIG. 10 indicates, for each device name, an error occurrence rate of errors relating to all types of jobs, an error occurrence rate of errors relating to print jobs, an error occurrence rate of errors relating to scan jobs, and an error occurrence rate of errors relating to fax jobs.

Note that an error occurrence rate of a given job is calculated by dividing the number of times an error has occurred in executing the given job by the total number of times the given job has been executed. That is, in the second embodiment, for each device name, the number of job executions of all types of jobs, the number of print job executions, the number of scan job executions, and the number of fax job executions are calculated. Then, for each device name, the error count of errors relating to all types of jobs, the error count of print job errors, the error count of scan job errors, and the error count of fax job errors may be divided by the above calculated numbers.

In the following, a third embodiment of the present invention is described. Note that the following descriptions relate to features of the third embodiment that differ from the first embodiment. Thus, features of the third embodiment that are not specifically mentioned below may be substantially identical to the first embodiment.

In the third embodiment, the content of the report information is different from that of the first embodiment. FIG. 11 is a table representing an example of report information according to the third embodiment.

The report information of FIG. 11 indicates the required printing time (sec/page) for a print job for each device name. The user may refer to such report information to identify an image forming apparatus 30 with a relatively long required printing time as a replacement target device, for example.

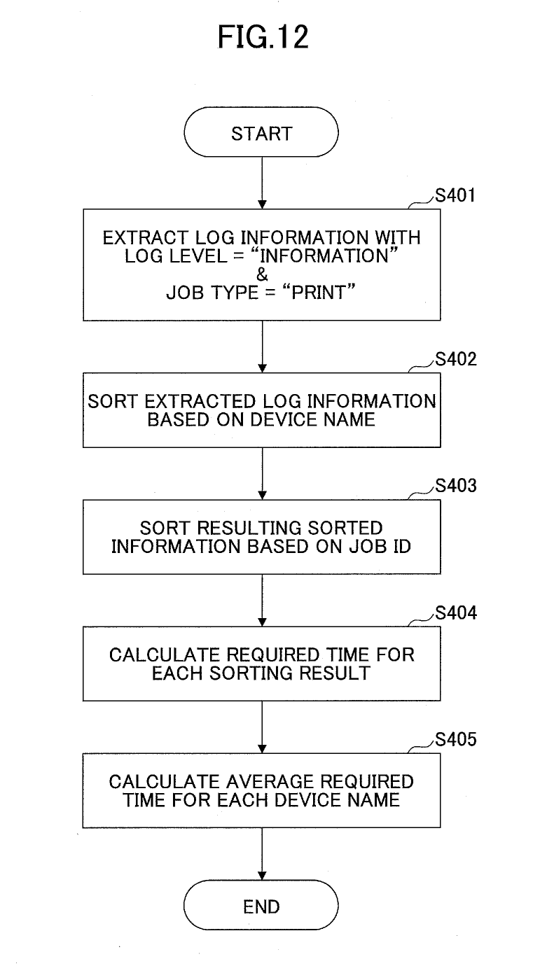

When generating the report information as illustrated in FIG. 11, the log information analyzing process of step S103 in FIG. 4 may be implemented by process steps as illustrated in FIG. 12, for example.

FIG. 12 is a flowchart illustrating example process steps of the log information analyzing process for analyzing a collection of log information according to the third embodiment.

In step S401, the log analyzing unit 13 extracts from the collection of log information acquired by the log acquiring unit 12, a collection of log information with the value “information” as the log level and the value “print” as the job type.

Then, in step S402, the log analyzing unit 13 sorts the extracted collection of log information into a plurality of groups based on the device name of each log information entry included in the extracted collection of log information. Note that in the descriptions below, the plurality of groups into which the extracted collection of log information is sorted are referred to as “device name groups”. Then, in step S403, the log analyzing unit 13 further sorts the log information included in each device name group into a plurality of groups based on the job ID of the log information. Note that in the descriptions below, the plurality of groups into which the log information included in a given device name group is sorted are referred to as “job-specific groups”. For example, with respect to the log information indicated in FIG. 5, the log information may be sorted into a job-specific group with the job ID “0001” and a job-specific group with the job ID “0003”. Note that the log information with the job ID “0002” has the value “scan” as the job type, and as such, this log information entry is excluded from the collection of log information subject to sorting in the extraction process of step S401.

Then, the log analyzing unit 13 calculates the required printing time for a print job for each job-specific group (step S404). Note that the required printing time for a given job-specific group (for a specific job) may be calculated by subtracting log information with the value “print start” as the details from log information with the value “print end” as the details included in the log information of the given job-specific group. That is, the log information with the value “print start” indicates the start of a print job, and the log information with the value “print end” indicates the end of the print job.

Then, the log analyzing unit 13 calculates an average value of the required printing time (average required printing time) for each device name group based on the required printing time calculated for each job-specific group (e.g., each print job) (step S405). In this way, the log analyzing unit 13 obtains an analysis result for generating the report information as illustrated in FIG. 11.

Note that in some embodiments, the required time for executing jobs other than print jobs may also be calculated. For example, with respect to the log information illustrated in FIG. 5, the average value of the required time for executing a print job, and the average value of the required time for executing a scan job may be calculated as follows.

Average Value of the Required Time for Print Job=(5.0+5.0)÷2=5.0 (seconds)

Average Value of Required Time for Scan Job=11.0÷1=11.0 (seconds)

As described above, according to an aspect of the third embodiment, a collection of log information acquired from an image forming apparatus 30 may be analyzed based on the log level and the job type of the log information to calculate a required printing time for each device name, for example, and report information including the analysis result may be generated. Thus, a user may refer to such report information to compare the performance of the image forming apparatuses 30 being managed by the device management system 1, for example.

Further, according to an aspect of the above-described embodiments of the present invention, in a device management system of an office or the like where several tens or more devices are managed, important historical information (log information) may be prevented from being buried amid the large amount of log information output by the devices without requiring review of all log information output by all the devices, for example.

Note that the report generating apparatus 10 in the above-described embodiments is an example of an information processing apparatus of the present invention. The log acquiring unit 12, the log analyzing unit 13, the report generating unit 14, and the report transmitting unit 15 are examples of processes implemented by a processor of the information processing apparatus. The log collecting unit 21 and the log management unit 22 are examples of processes implemented by a first processor of a device management apparatus of the present invention. The values “error” and “fatal” for the log level of log information are examples of a first value of an information item for controlling an output level of historical information according to the present invention. The value “information” for the log level of log information is an example of a second value of the information item according to the present invention. Also, the event date/time of log information is an example of time information according to the present invention.

Although the present invention has been described above with reference to certain illustrative embodiments, the present invention is not limited to these embodiments, and numerous variations and modifications may be made without departing from the scope of the present invention.

What is claimed is:

1. An information processing apparatus that is connected to a device management apparatus via a network, the information processing apparatus comprising:
a memory storing a program; and
a processor configured to execute the program to implement processes of
acquiring a collection of historical information output in connection with execution of a process by a device that is managed by the device management apparatus;
analyzing the acquired collection of historical information based on a value of an information item included in each entry of historical information of the acquired collection of historical information, the information item being used to control an output level of historical information to be output;
generating information in an output format based on an analysis result of analyzing the acquired collection of historical information; and
outputting the generated information in the output format.

2. The information processing apparatus according to claim 1, wherein
the processor further implements a process of extracting, from the acquired collection of historical information, a collection of historical information having a first value as the information item for controlling the output level of historical information, sorting the extracted collection of historical information into a plurality of groups based on a process type of the process associated with each entry of historical information of the extracted collection of historical information, and counting a number of historical information entries included in each group of the plurality of groups into which the extracted collection of historical information has been sorted.

3. The information processing apparatus according to claim 1, wherein
the processor further implements a process of extracting from the acquired collection of historical information, a collection of historical information having a second value as the information item for controlling the output level of historical information, and calculating an average required time for the process associated with the historical information based on time information included in each entry of historical information of the extracted collection of historical information.

4. The information processing apparatus according to claim 1, wherein
the information item for controlling the output level of historical information is used for narrowing down the historical information to be output by the device.

5. A device management system comprising:
a device management apparatus that is connected to a device via a network; and
an information processing apparatus that is connected to the device management apparatus via the network;
wherein the device management apparatus includes
a first memory storing a first program; and
a first processor configured to execute the first program to implement processes of
acquiring from the device, a collection of historical information output in connection with execution of a process by the device; and
transmitting the acquired collection of historical information to the information processing apparatus; and
wherein the information processing apparatus includes
a second memory storing a second program; and
a second processor configured to execute the second program to implement processes of
receiving the acquired collection of historical information from the device management apparatus;
analyzing the acquired collection of historical information based on a value of an information item included in each entry of historical information of the acquired collection of historical information, the information item being used to control an output level of historical information to be output;
generating information in an output format based on an analysis result of analyzing the acquired collection of historical information; and
outputting the generated information in the output format.

6. An information processing method comprising steps of:
acquiring a collection of historical information output in connection with execution of a process by a device that is connected to a device management apparatus via a network;
analyzing the acquired collection of historical information based on a value of an information item included in each entry of historical information of the acquired collection of historical information, the information item being used to control an output level of historical information to be output;
generating information in an output format based on an analysis result of analyzing the acquired collection of historical information; and
outputting the generated information in the output format.
